(19) United States
(12) Patent Application Publication
(10) Pub. No.: US 2021/0280852 A1
(43) Pub. Date: Sep. 9, 2021

(54) DEVICE AND METHOD FOR FAST CHARGE OF BATTERIES

(71) Applicants: THE RESEARCH FOUNDATION FOR THE STATE UNIVERSITY OF NEW YORK, Albany, NY (US); BROOKHAVEN SCIENCE ASSOCIATES, LLC, Upton, NY (US)

(72) Inventors: Esther S. Takeuchi, South Setauket, NY (US); Amy C. MARSCHILOK, Stony Brook, NY (US); Kenneth TAKEUCHI, South Setauket, NY (US); David C. BOCK, Moriches, NY (US)

(73) Assignees: The Research Foundation For The State University of New York, Albany, NY (US); Brookhaven Science Associates, LLC, Upton, NY (US)

(21) Appl. No.: 16/962,970

(22) PCT Filed: Jan. 18, 2019
(86) PCT No.: PCT/US2019/014095

§ 371 Date: Jul. 17, 2020

Related U.S. Application Data
(60) Provisional application No. 62/618,116, filed on Jan. 17, 2018.

(51) Int. Cl. H01M 4/36; H01M 4/133; H01M 10/0525

(52) U.S. Cl. CPC H01M 4/366; H01M 2004/027; H01M 10/0525; H01M 4/133

(57) ABSTRACT

An anode configured for fast charging a lithium-ion battery includes an anode substrate and a coating provided on a surface of the anode substrate for increasing an overpotential of Li metal to inhibit Li metal plating during extreme fast charging a lithium-ion battery fabricated with the anode. The anode is fabricated by a process of applying a coating to the anode substrate surface that comprises a nanolayer of Cu, or a nanolayer of Ni or a composite nanolayer of Cu and Ni.

### CROSS-REFERENCE TO RELATED APPLICATIONS

This application derives the benefit of the filing date of U.S. Provisional Patent Application No. 62/618,116, filed Jan. 17, 2018. The contents of the provisional application are incorporated by reference in this application.

### GOVERNMENT SUPPORT STATEMENT

This invention was made with government support under DE-FOA-0001818 and DE-EE0008356 awarded by the US Department of Energy. The government has certain rights in the invention.

### BACKGROUND OF THE INVENTION

The invention broadly relates to lithium-ion batteries, and more particularly relates to a lithium-ion cell or battery for fast charge that includes an anode formed for increasing overpotential of Li metal nucleation and growth relative to an uncoated anode surface (e.g., graphite), thus inhibiting Li deposition (“metal plating”) during extreme fast charging, while still facilitating Li-ion diffusion into the graphite substrate. By mitigating Li plating, the cell or battery with a graphite anode so fabricated with the coating addresses the EERE goal of achieving 500 cycles with less than 20% fade in specific energy using a 10-minte fast charging protocol. The coating in the aggregate is between about 2 and 200 nm in thickness, preferably between about 2 and 10 nm (for example, 5 nm).

### BACKGROUND OF THE RELATED ART

Currently produced electric vehicles (EVs) rely on the use of lithium ion battery technology due to its high energy and power density, as well as its relative technological maturity compared to other emerging systems such as Li/S and Li/O₂. Ahmed, S., et al., Enabling fast charging—A battery technology gap assessment. Journal of Power Sources (2017); 367(Supplement C): p. 250-262. However, a major barrier facing the adoption of electric vehicles is that currently utilized Li-ion batteries take significantly longer to recharge (˜30 minutes) compared to the time necessary to refuel vehicles powered by internal combustion engines (<10 minutes). Thus, the need to develop Li-ion batteries which can be charged in approximately 10 minutes (6 C rate) without sacrificing range, cost, or cycle life is critical for the widespread implementation of EVs.

A major barrier preventing extreme fast charging of state of the art Li-ion batteries is the occurrence of lithium metal deposition, or lithium plating, at the graphite anode, as reported by Nitta, N., et al., Li-ion battery materials: present and future. Mater. Today (Oxford, U. K.) (2015); 18(5): p. 252-264. Graphite anodes operate at a working potential of 0.05-0.1 V vs. Li/Li+, as reported by Waldmann, T., et al., Interplay of Operational Parameters on Lithium Deposition in Lithium-Ion Cells: Systematic Measurements with Reconstructed 3-Electrode Pouch Full Cells. Journal of The Electrochemical Society (2016); 163(7): p. A1232-A1238; Liu, Q., et al., Understanding undesirable anode lithium plating issues in lithium-ion batteries. RSC Adv. (2016); 6(91): p. 88683-88700; Agubra, V. and J. Fergus, Lithium Ion Battery Anode Aging Mechanisms. Materials (2013)6 (4): p. 1310.

Thus, the operational voltage is very close to that of metallic Li deposition. Under normal charging conditions at low rates, Li+ ions intercalate into the graphite anode. However, under fast charging conditions, the transport rate of Li+ ions to the anode surface is greater than the rate of Li+ diffusivity in graphite, resulting in the accumulation of Li+ions at the electrode surface. Waldmann, T., et al., Interplay of Operational Parameters on Lithium Deposition in Lithium-Ion Cells: Systematic Measurements with Reconstructed 3-Electrode Pouch Full Cells, Journal of The Electrochemical Society (2016); 163(7): p. A1232-A1238. These conditions cause polarization of the electrode below the 0V threshold for Li deposition, resulting in Li plating. The lithium deposition is dependent on charging conditions, where fast rates, low temperature and high state of charge (SOC) all increase electrode polarization and thus facilitate Li deposition. Liu, Q., et al., Understanding undesirable anode lithium plating issues in lithium-ion batteries. RSC Adv (2016); 6(91): p. 88683-88700.

The lithium deposition is dependent on charging conditions, where fast rates, low temperature and high state of charge (SOC) all increase anode polarization facilitating Li deposition. Q. Liu, et al. RSC Adv., 6, 88683 (2016). Fast charging capability of state of the art Li-ion batteries is limited by the occurrence of Li plating at the graphite anode, which operates at a working potential between 0.05-0.1 V vs. Li/Li⁺. T. Waldmann, et al. J. Electrochem. Soc., 163, A1232 (2016); Q. Liu, et al. RSC Adv., 6, 88683 (2016); 5. V. Agubra, et al. Materials, 6, 1310 (2013).

When the anode is polarized below OV, Li deposition on the graphite surface is favored over intercalation, and plating occurs. Because of the high reactivity of Li metal, subsequent reaction with the electrolyte occurs, consuming some of the active lithium and resulting in cell capacity loss.

To suppress Li plating, multiple strategies have been demonstrated with limited effectiveness including optimization of electrolyte composition to increase ionic conductivity and/or control SEI resistance, Jones, J.P., et al., The Effect of Electrolyte Composition on Lithium Plating During Low Temperature Charging of Li-Ion Cells. ECS Transactions (2017); 75(21): p. 1-11; Liu, Q.Q., et al., Effects of Electrolyte Additives and Solvents on Unwanted Lithium Plating in Lithium-Ion Cells.Journal of The Electrochemical Society (2017) 164(6): p. A1173-A1183, 13. Jurng, S., et al., Low-Temperature Performance Improvement of Graphite Electrode by Allyl Sulfide Additive and Its Film-Forming Mechanism. Journal of The Electrochemical Society (2016); 163(8): p. A1798-A1804. Smart, M. C. and B. V. Ratnakumar, Effects of Electrolyte Composition on Lithium Plating in Lithium-Ion Cells. Journal of The Electrochemical Society (2011); 158(4): p. A379-A389; Smart, M.C., et al., Lithium-Ion Electrolytes Containing Ester Cosolvents for Improved Low Temperature Performance. Journal of The Electrochemical Society (2010); 157(12): p. A1361-A1374; Smart, M. C., B. V. Ratnakumar, and S. Surampudi, Use of Organic Esters as Cosolvents in Electrolytes for Lithium-Ion Batteries with Improved Low Temperature Performance. Journal of The Electrochemical Society (2002); 149(4): p. A361-A370.

Known mitigating Li plating includes modification of the graphite anode to improve diffusion kinetics, as reported by Cheng, Q., et 1., KOH etched graphite for fast chargeable lithium-ion batteries. Journal of Power Sources (2015); 284(Supplement C): p. 258-263; Deng, T. and X. Zhou, Porous graphite prepared by molybdenum oxide catalyzed gasification as anode material for lithium ion batteries. Materials Letters (2016); 176 (Supplement C): p. 151-154; Park, J.-S., et al., Edge-Exfoliated Graphites for Facile Kinetics of Delithiation. ACS Nano (2012); 6(12): p. 10770-10775; Shim, J. H. and S. Lee, Characterization of graphite etched with potassium hydroxide and its application in fast-rechargeable lithium ion batteries. Journal of Power Sources (2016); 324(Supplement C): p. 475-483, and optimization of charging protocol. T. Waldmann, et al. J. Electrochem. Soc., 163, A1232 (2016); Ahmed, S., et al., Enabling fast charging—A battery technology gap assessment. Journal of Power Sources (2017); 367(Supplement C): p. 250-262. Somerville, L., et al., The effect of charging rate on the graphite electrode of commercial lithium-ion cells: A post-mortem study. Journal of Power Sources (2016); 335 (Supplement C): p. 189-196; Zhang, S. S., The effect of the charging protocol on the cycle life of a Li-ion battery. Journal of Power Sources (2006); 161(2): p. 1385-1391. Waldmann, T., M. Kasper, and M. Wohlfahrt-Mehrens, Optimization of Charging Strategy by Prevention of Lithium Deposition on Anodes in high-energy Lithium-ion Batteries—Electrochemical Experiments. Electrochimica Acta (2015); 178 (Supplement C): p. 525-532. Based on the current body of research, none of the above strategies can provide enough benefit to enable cycling at extreme fast charging rates. Thus, the exploration of new approaches for suppressing Li deposition during fast charging is warranted.

Control of Li deposition overpotential using Ni and Cu metal substrates—During the deposition of lithium via an electrocrystallization process, there is a free energy barrier that must be overcome for the formation Li nuclei on the electrode surface to occur. An overpotential is needed to surmount this thermodynamic cost and drive the reaction. In theory, the total overpotential for the electrouystallization is the sum of four distinct contributions:

η=η_{ct}+η_{d}+ηᵣ+η_{c} (Equation 1)

where η_{ct}, η_{d}, ηᵣ, and η_{c} are charge transfer, diffusion, reaction, and crystallization overpotentials, respectively, as reported by Winand, R., Electrocrystallization: Fundamental considerations and application to high current density continuous steel sheet plating. Journal of Applied Electrochemistry, 1991. 21(5): p. 377-385.

However, in practice it is difficult to extract all four of these parameters from experimental data. As shown in recent work Pei, A., et al., Nanoscale Nucleation and Growth of Electrodeposited Lithium Metal. Nano Letters (2017); 17(2): p. 1132-1139, the electrode polarization during electrocrystallization of Li can be more simply be described as the sum of two terms: the nucleation overpotential (ηₙ), associated with initial nucleation of Li clusters and observed as an initial voltage drop, and the plateau overpotential (ηₚ) which describes the continued growth of Li on existing nuclei. (FIG. 7). It is notable that value of ηₚ is higher than ηₙ. This is because the addition of Li atoms to pre-formed nuclei has a lower thermodynamic cost than initial nucleation. Sagane, F., et al., Effects of current densities on the lithium plating morphology at a lithium phosphorus oxynitride glass electrolyte/copper thin film interface. Journal of Power Sources, 2013. 233 (Supplement C): p. 34-42.

The overpotential for Li electrocrystallization is highly dependent on the electrode substrate, Nickel (Ni) and copper (Cu) metal substrates in particular exhibit high overpotentials unfavorable for lithium deposition (FIG. 2a). The overpotentials for Li deposition on Cu and Li at low current density (10 μA cm-2) were determined to be −40 mV and −30 mV, respectively, compared to an overpotential of ˜−15 mV on a carbon substrate. as reported by Yan, K., et al., Selective deposition and stable encapsulation of lithium through heterogeneous seeded growth. Nat. Energy, 2016. 1(3): p. 16010. The proposed approach will take advantage of the high overpotentials on Cu and Ni substrates to suppress Li plating on metal coated electrodes.

The driving force for the overpotential during Li nucleation is the interfacial energy difference between the substrate and Li metal, which is dependent on the dissimilarity in crystal structure between Li and the substrate for deposition. Both Cu and Ni crystallize in an FCC structure, while Li metal is BCC. Moreover, the atomic radii of Cu and Ni are 1.28 Å and 1.24 Å, respectively, compared to 1.55 Å for Li metal. Pauling, L., Atomic Radii and Interatomic Distances in Metals. Journal of the American Chemical Society, 1947. 69(3): p. 542-553.

Thus, an overpotential is necessary to overcome the energy barrier associated with the structural mismatch during Li nucleation on the metal surface. as reported by Yan, K., et al., Selective deposition and stable encapsulation of lithium through heterogeneous seeded growth. Nat. Energy, 2016. 1(3): p. 16010. Further insight into the high overpotentials for Li deposition on Ni and Cu is gained by inspection of binary phase diagrams between Li and Cu or Ni (FIG. 5). Neither Cu nor Ni form an alloy compound phase with Li at room temperature. Furthermore, there is no single phase solubility of Cu or Ni in Li at room temperature, which would otherwise decrease the energy barrier for Li nucleation. Thus, high overpotentials are needed to drive the Li deposition reaction on Cu and Ni surfaces.

The overpotentials for Li electrodeposition are also dependent on current density, as reported by Pei, A., et al., Nanoscale Nucleation and Growth of Electrodeposited Lithium Metal. Nano Letters, 2017. 17(2): p. 1132-1139. As shown in FIG. 2b, for electrodeposition of Li on a Cu foil substrate, ηₙ increases from −50 mV at a current density of 0.1 mA/cm2 (red) to −350 mV at current density of 5 mA/cm² (purple), while ηₚ increases from −30 mV at 0.1 mA/cm² to approximately −140 mV at 5 mA/cm². As illustrated, current densities at 0.3 mA/cm2, 0.5 mA/cm2 and 1 mA/cm2 are illustrated in orange, green and blue, respectively in FIG. 2b.

In comparison, electrode overpotentials for graphite/NMC cells cycled at a 3C rate (ca. 6 mA cm⁻² current density for a 2 mAh cm⁻² graphite loading) are reported to range from −50 mV to −150 mV (FIG. 3). Thus, at similar current densities, the overpotential for Li deposition on Cu is of greater magnitude than the overpotential for lithiation of graphite. The overpotential values strongly suggest that that Li metal nucleation and growth on metal-coated graphite electrodes will be significantly suppressed at high charge rates and insertion of Li ions into graphite will be the more favorable process.

### SUMMARY OF THE INVENTION

The invention provides an entirely new concept in an anode for use in a lithium-ion battery cell, where the overpotential for Li metal deposition at the surface is deliberately increased, thus inhibiting Li metal deposition during extreme fast charging of a lithium-ion battery cell fabricated with the anode. This is accomplished by coating graphite anode substrates with ultrathin coatings of Cu and/or Ni metal, which have high overpotentials unfavorable for lithium deposition. The nanometer scale thickness of the metal coatings (in a range of 2-200 nm, preferably in a range of 2-10 nm (e.g., 5 nm)) enables the function of the graphite anode to be maintained and preserves state of the art energy density. By suppressing Li plating, the resulting NCM/graphite battery addresses the EERE goal of achieving 500 cycles with less than 20% fade in specific energy using a 10-minute fast charging protocol.

### BRIEF DESCRIPTION OF THE DRAWINGS

Further features and advantages of the invention will become apparent from the description of embodiments that follows, with reference to the attached figures, in which:

FIG. 1 is a schematic representation of (a) prior art Li-plating on graphite surface during fast charging rates and (b) preferential intercalation into graphite due to increased overpotential for Li nucleation afforded by a Cu or Ni surface coating, according to the invention.

FIG. 2 graphically illustrates (a) voltage profiles of Li deposition under galvanostatic control on Ni and Cu substrates at a 10 μA cm⁻² current density, with scaling on the vertical axis of 50 mV and (b) Voltage profiles of Li deposition on copper substrate at current potentials up to 5 mA/cm².

FIG. 3 graphically illustrates anode potential measurements vs. (Li/Li⁺) of 3 electrode cells with graphite anode, lithium nickel cobalt manganese oxide (Li_{w}NiₓCo_{y}Mn_{z}O₂) (NMC) cathode, Li reference electrode and 1:1 (ethylene carbonate:dimethyl carbonate (EC:DMC) 1 M LiPF₆ charged at (a) 5° C., (b) 20° C., and (b) 45° C., respectively. Measurements were collected on cells with charging rates ranging from 0.2 C to 3 C.

FIG. 4 graphically illustrates voltage profiles of galvanostatic Li deposition (black) and double pulse potentiostatic Li deposition (red) showing the nucleation overpotential (ηₙ) and plateau overpotential (ηₚ) associated with the electrodeposition process. Pei, A., et al., Nanoscale Nucleation and Growth of Electrodeposited Lithium Metal. Nano Letters, 2017. 17(2): p. 1132-1139.

FIG. 5 graphically illustrates binary phase diagrams of Li with (a) Cu and (b) Ni (from 2: Yan, K., et al., Selective deposition and stable encapsulation of lithium through heterogeneous seeded growth. Nat. Energy, 2016. 1(3): p. 16010.

FIG. 6(a) illustrates CVs of pristine carbon fiber.

FIG. 6(b) illustrates carbon fiber with a 40 nm thick Cu film deposited via physical vapor deposition. FIG. 6(c) illustrates the relationship between Cu film thickness and anodic peak height for Li deinsertion from Cu-coated carbon fibers.

FIG. 7 graphically illustrates energy obtained at various discharge rates for Si and Cu-coated Si, wherein values are normalized vs. energy obtained at C/8 rate.

FIGS. 8(a) and (b) are Nyquist plots as a function of electrode potential for (a) pristine graphite electrodes and (b) graphite electrodes coated with a 5 nm layer of Cu.

### DETAILED DESCRIPTION OF THE INVENTION

The following detailed description of embodiments of the invention will be made in reference to the accompanying drawings. In describing the invention, explanation about related functions or constructions known in the art are omitted for the sake of clarity in understanding the concept of the invention to avoid obscuring the invention with unnecessary detail.

The invention provides an electrode (e.g., an anode) and method of forming the electrode for fast charging lithium-ion batteries fabricated with the electrode, an electrode or anode formed by the method and a cell or battery fabricated with the electrode/anode in order to fast charge.

In one form, the invention embodies a graphite electrode (that is, an anode) coated with ultrathin layers of Cu and/or Ni metal nanoparticles to realize a coating that is approximately 2-10 nm thick, in order to increase the overpotential of Li metal nucleation at the electrode/anode surface, when operational in a cell or battery fabricated with the coated graphite anode. The coating inhibits Li metal plating during extreme fast charging in reliance upon the inventive anode (of the cell or battery). By mitigating Li plating, the resulting graphite/nano coated material (NMC) cell or battery addresses the US Office of Energy Efficiency and Renewable Energy (EERE) goal of achieving 500 cycles with less than 20% fade in specific energy using a 10-minute fast charging protocol.

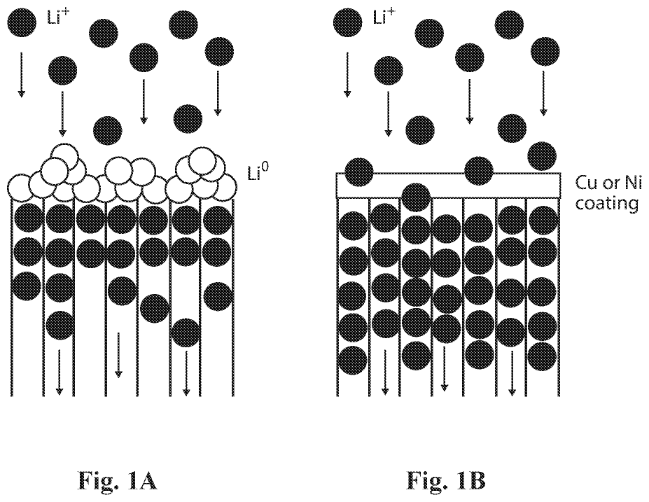

The graphite anodes are coated with nanometer scale (<20 nm) layers of Ni and Cu metal that are applied to the surface of the anode substrate via DC magnetron sputtering. Ni and Cu metal substrates have high overpotentials unfavorable for lithium deposition. Yan, K., et al., Selective deposition and stable encapsulation of lithium through heterogeneous seeded growth. Nat. Energy, 2016. 1(3): p. 16010; Pei, A., et al., Nanoscale Nucleation and Growth of Electrodeposited Lithium Metal. Nano Letters, 2017. 17(2): p. 1132-1139. During charging of a cell or battery fabricated with the coated graphite anode, the overpotentials for Li deposition on the metal coated anode substrate surface is greater in magnitude than the overpotential for intercalation into graphite (FIG. 1a), resulting in preferred lithiation of graphite and inhibited Li plating (FIG. 1b). Suppression of Li deposition will allow the battery to be charged using a 10 minute protocol over extended cycling (>500 cycles).

The metal coated graphite anode is paired with LiNi_{0.6}Mn_{0.2}Co_{0.2}O₂ (622 NCM) cathode, polymer separator and 1 M LiPF_{6 3:7} EC: EMC based electrolyte. The proposed cell will utilize current state of the art electrode materials (graphite and 622 NCM), with the only difference being modification of the graphite anode substrate surface via a DC magnetron sputtering method; thus, the cost of the proposed cell will be comparable to the current state of the art. Furthermore, because the ultrathin metal coatings will be deposited only on the surface of the graphite anode substrate, there will not be a significant increase in inactive anode mass. For a graphite anode with 8 mg/cm² loading, the mass of a 5 nm Cu coating on the anode (substrate) surface would be <1 mg Cu per g of graphite. Thus, cell specific energy also is maintained relative to the current state of the art.

The inventors prepare and characterize a graphite anode coated with a nanometer scale Ni layer, a nanometer Cu layer or a composite nanolayer of Cu and Ni. Electrochemical evaluation is performed on the graphite anode with the coating in half and full cell configurations, by comparing fast charge operation of cells containing the Cu/Ni coated electrodes (i.e., anodes) with uncoated graphite anodes.

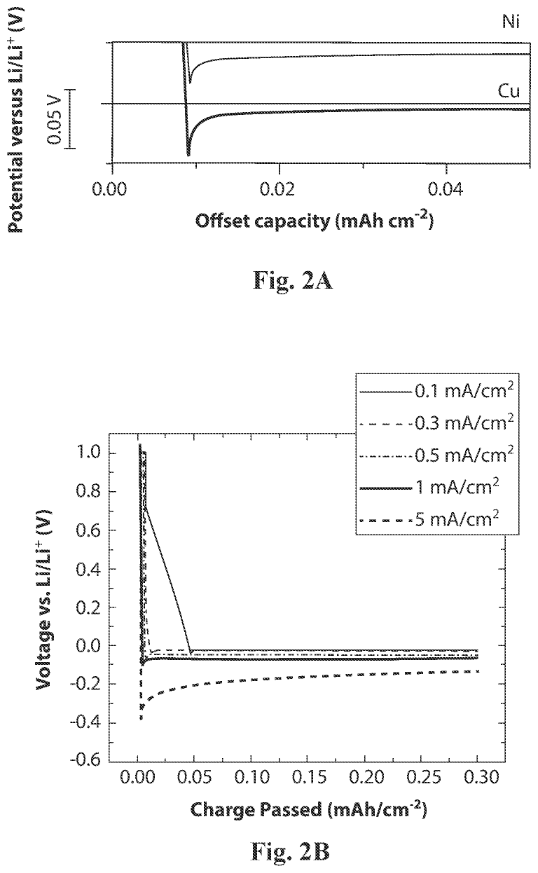

As is known in the art, materials with high overpotential prevent Li metal deposition. For that matter, recent reports indicate that nickel (Ni) and copper (Cu) metal substrates have high overpotentials unfavorable for lithium deposition (FIGS. 2a, 2b). K. Yan, et al. Nat. Energy, 1, 16010 (2016); A. Pei, et al. Nano Lett., 17, 1132 (2017).

The inventive anode and method of fabricating the anode exploit this high overpotentials for Li deposition on Cu and Ni metal substrates to inhibit Li plating during fast charging protocol in battery cells and batteries manufactured with the anodes. The inventive method utilizes DC magnetron sputtering to deposit nanometer scale layers of Ni and/or Cu on prefabricated graphite anodes, where the controlled ultra-thin metal coatings increased the overpotential for Li metal deposition thus inhibiting Li plating during extreme fast charging while still maintaining the function of the graphite electrode (FIGS. 1a and 1b).

The specific overpotential value of Li deposition on Ni and Cu substrates depends on current density, with values of −350 mV reported for a Cu substrate at current densities of 5 mA cm⁻² (FIG. 2b). Ahmed, S., et al., Enabling fast charging—A battery technology gap assessment. Journal of Power Sources, 2017. 367 (Supplement C): p. 250-262.

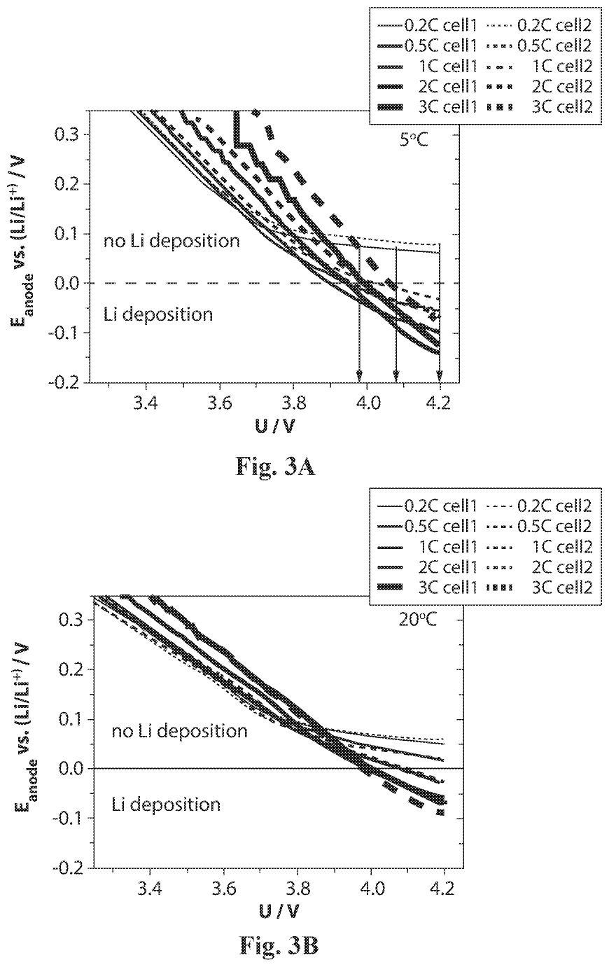

In comparison, electrode overpotentials for graphite/nano material (NMC) cells cycled at a 3C rate (ca. 6 mA cm⁻² current density for a 2 mAh cm⁻² graphite loading) are reported to range from −50 mV to −150 mV (FIGS. 3a, 3b, 3c). T. Waldmann, et al. J. Electrochem. Soc., 163 (7), A1232 (2016). As illustrated, solid gray indicates 0.2C cell 1, solid red indicates 0.5 cell 1, solid orange indicates 1C cell 1, solid blue indicates 2C cell 1 and solid gray indicates 3C cell 1, respectively; dashed gray indicates 0.2C cell 2, dashed red indicates 0.5 cell 2, dashed orange indicates 1C cell 2, dashed blue indicates 2C cell 2 and dashed gray indicates 3C cell 2, respectively. The overpotentials for Li deposition on Cu substrates are greater in magnitude than the reported graphite electrode overpotentials at similar current densities, thus, graphite anode substrates coated with a thin layer Ni and/or Cu metal mitigate Li surface deposition, favoring lithium insertion into graphite, and enabling extreme fast charging with inhibited Li plating.

An inventive anode is fabricated with current state of the art anode materials (graphite and 622 NMC) and 1 M LiPF6 3:7 EC: EMC electrolyte. The only difference in fabrication compared to current state of the art Li-ion batteries is modification of the graphite electrode surface via DC magnetron sputtering deposition. Thus, the cost of the proposed cell fabricated with the inventive anode is comparable to the current state of the art. And because the ultra-thin metal coatings are deposited only on a surface of the graphite anode, i.e., the substrate surface, cell specific energy is maintained. For graphite anodes with 8 mg/cm2 loading coated with a 5 nm Cu layer, the inactive mass on the electrode surface will be <1 mg Cu per g of graphite. Suppression of Li deposition will allow the battery to be charged using a 10 minute protocol over extended cycling (>500 cycles).

In the inventive device and method, the overpotential for Li metal nucleation at the anode's surface is deliberately increased, thus inhibiting Li metal deposition during extreme fast charging while still maintaining the function of a known graphite electrode/anode (FIG. 1a).

As known, the driving force for the overpotential during heterogeneous nucleation of Li is the interfacial energy difference between the substrate and Li metal, which is dependent on the dissimilarity in crystal structure between Li and the substrate for deposition. Both Cu and Ni crystallize in a face centered cubic (FCC) structure, while Li metal is base centered cubic (BCC) structure. Thus, an overpotential is necessary to overcome the energy barrier associated with the structural mismatch during Li nucleation on the metal surface.

For the inventive method, graphite/carbon black/polyvinylidene fluoride (PVDF) electrodes are fabricated using a slurry casting method. The electrodes, i.e., the surface of the electrode substrates, are the coated with Cu and Ni using a physical vapor deposition (PVD) method where the metals are evaporated under vacuum from a heated tungsten crucible. F. Nobili, et al. J. Power Sources, 180, 845 (2008); M. Mancini, et al. J. Power Sources, 190, 141 (2009); J. Suzuki, et al. Electrochem. Solid-State Lett., 4, A1 (2001); F. Nobili, et al. Fuel Cells (Weinheim, Ger.), 9, 264 (2009).

Deposition rate and thickness is monitored by measuring the electrode mass using a quartz crystal microbalance (QCM), and the temperature and deposition time is adjusted to obtain Ni and Cu layers ranging from 2-10 nm. It is our understanding that the coating occurs primarily on the surface of the electrode, for a graphite anode with 8 mg/cm² loading, the metal mass is <1 mg per g of graphite for a 5 nm Cu coating.

High Resolution Transmission Electron Microscopy (HR-TEM) is used to determine the homogeneity and thickness of the metallic films. The coated anodes are paired with LiNi_{0.6}Mn_{0.2}Co_{0.2}O₂ (622 NCM) cathodes and are evaluated using a 1 M LiPF₆ 3:7 EC:EMC based electrolyte. The electrolyte additives vinylene carbonate (VC), as reported by J. C. Burns, et al. J. Electrochem. Soc. , 160, A1668 (2013); D. Aurbach, et al. Electrochim. Acta, 47, 1423 (2002) and fluoroethylene carbonate (FEC), as reported by H. Shin, et al. J. Electrochem. Soc., 162, A1683 (2015); B. Liu, et al. Electrochem. Solid-State Lett., 15, A77 (2012), which have been utilized for forming a more robust anode SEI in Li ion cells, are evaluated for modifying the sold-electrolyte interphase (SEI).

Systematic investigation of Ni and Cu coating thickness, cell temperature, charging rate, and state of charge (SOC) on Li plating cycle life is performed in 2 and 3 electrode cell configurations. Li deposition is detected and quantified by differential voltage plots, as reported by J. P. Jones, et al. ECS Trans., 75, 1 (2017); M. Petzl Journal of Power Sources, 254, 80 (2014), measuring the anode potential in a 3 electrode cell configuration, T. Waldmann, et al. J. Electrochem. Soc., 163, A2149 (2016); S. S. Zhang, J. Power Sources, 161, 1385 (2006), and monitoring heat flows associated with Li deposition using isothermal microcalorimetry. L. E. Downie, et al. J. Electrochem. Soc., 160, A588 (2013). Extended cycling performance of coated anodes demonstrating optimum electrochemical behavior is further evaluated in 2 Ah pouch cells.

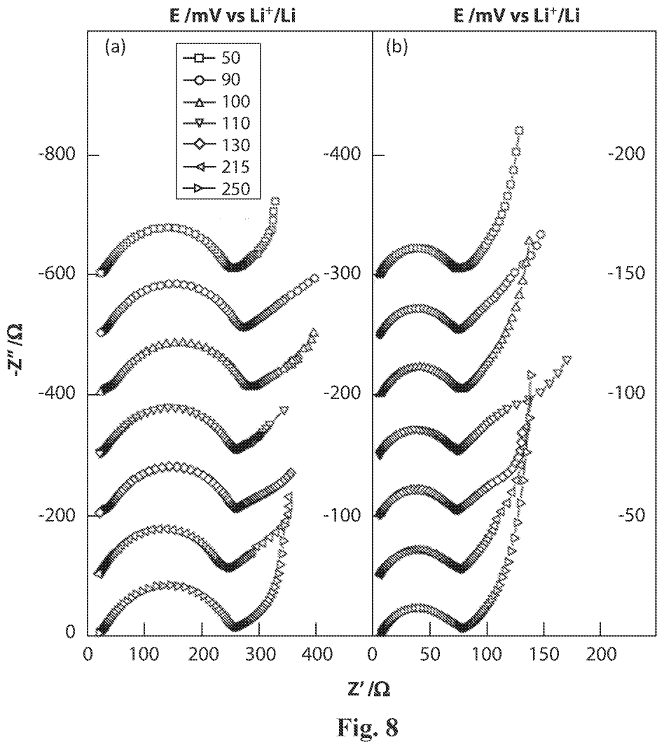

The presence of Ni and/or Cu coatings on graphite anodes increase the Li nucleation overpotential relative to the uncoated graphite anode, suppressing Li deposition. Additionally, the metallic layer decreases the charge transfer resistance of the graphite electrodes (as shown in FIG. 8). F. Nobili, et al. J. Power Sources, 180, 845 (2008). Thus, the device and method enables extreme fast charging by inhibiting the kinetics of Li metal plating while simultaneously improving the charge transfer kinetics at the graphite anode.

Scientific and Other Principles

A first objective is to prepare and characterize graphite electrode coated with nanometer scale Ni or Cu layers. The primary scientific inquiry under this objective is the control of metal coating thickness and uniformity. Graphite electrodes were fabricated with target active material loading of 6 mg/cm². DC magnetron sputtering deposition was used to deposit nanometer scale (<20 nm) layers of Ni and Cu on the graphite electrodes. The film thickness and uniformity were optimized through control of sputtering time and sputtering power. Thickness was monitored during the deposition using a quartz crystal microbalance mounted in the deposition vacuum chamber adjacent to the substrate. Deposited film thicknesses were confirmed via atomic force microscopy (AFM) measurements of a foil substrate with a stepped region between metal coated and uncoated areas, as reported by Lindner, M. and M. Schmid, Thickness Measurement Methods for Physical Vapor Deposited Aluminum Coatings in Packaging Applications: A Review. Coatings (2017); 7(1): p. 9.

The metal coated electrodes are characterized via SEM measurements, including secondary electron, backscatter electron, and energy dispersive spectroscopy (EDS) mapping techniques. EDS mapping is used to evaluate the coverage homogeneity of the metal films by identifying the presence of cracks or voids.

A second objective is to perform electrochemical evaluation of Ni-graphite and Cu-graphite electrodes in half and full cell configurations. Electrodes utilizing LiNi_{0.6}Mn_{0.2}Co_{0.2}O₂ (622 NCM) cathodes were prepared with target cathode: anode capacity ratio of 1:1.2. Initial electrochemical evaluation of uncoated graphite electrodes, Ni-graphite and Cu-graphite electrodes, and NCM cathodes was performed using half cells in coin cell format. AC impedance, galvanostatic cycling, and rate capability testing will be used to characterize the various electrode types.

Post electrochemical testing evidence for Li metal deposition on the working electrode of cells containing uncoated and coated graphite anodes is investigated through destructive analysis. Optical microscopy will be used to inspect anode surfaces for lithium deposits, as reported by Park, G., et al., The study of electrochemical properties and lithium deposition of graphite at low temperature. Journal of Power Sources (2012); 199(Supplement C): p. 293-299; Waldmann, T., et al., Temperature dependent ageing mechanisms in Lithium-ion batteries—A Post-Mortem study. Journal of Power Sources (2014); 262(Supplement C): p.129-135; Gallagher, K. G., et al., Optimizing Areal Capacities through Understanding the Limitations of Lithium-Ion Electrodes. Journal of The Electrochemical Society (2016); 163(2): p. A138-A149.

The electrodes will also be imaged using SEM to visualize Li dendrite formation on the graphite anode surface, as reported by Honbo, H., et al., Electrochemical properties and Li deposition morphologies of surface modified graphite after grinding. Journal of Power Sources (2009); 189 (1): p. 337-343. Single layer full cells (NCM/graphite) were then be prepared in pouch cell format. Electrochemical performance of the Ni-graphite and Cu-graphite electrodes in the full cell configuration was determined via galvanostatic cycling. Go/No-Go decisions were made based on demonstration of a least one metal coated anode that is capable of delivering 25 cycles at a C/2 charge rate with less than 20% capacity fade.

A third objective is to optimize cell rate capability and cycle life through systematic study of metal coating type and thickness. The scientific focus of objective 3 was to determine the relationship between electrochemical performance and metal coating type and thickness. Graphite electrodes coated with Ni or Cu at three thicknesses between 2-20 nm were prepared, for a total of 6 unique coating types. Electrochemical evaluation was performed using single layer pouch full cells. Testing included AC impedance, rate capability, and galvanostatic cycling. Coating types which deliver the highest capacity at a 2C charge rate were further studied Post electrochemical characterization, evidence of Li-metal deposition will be determined via optical microscopy and SEM and was correlated to capacity loss.

A fourth objective is to evaluate extreme fast charge of cells containing metal coated graphite electrodes and benchmark with cells using uncoated graphite electrodes, by determining the extreme fast charge capability of the optimized metal coated graphite electrode and benchmark versus uncoated graphite. Single layer full cells utilizing the two metal coatings identified from the results of the third objective as having the best cycling performance were prepared and tested at a 3C rate. An additional down selection was made based on the metal coated anode with the highest capacity after 100 cycles. Additional single layer full cells were prepared using the optimized electrode as well as uncoated graphite electrodes. The cells were galvanostatically cycled at an extreme fast charge rate (6C) at multiple temperatures. The results of the testing were used to verify that the project goal—a metal coated electrode with functional capacity at 6C rate that is greater than that of an uncoated graphite anode—was achieved.

Expected outcomes to meet specific DOE technical targets are Realized—The inventive cell or battery fabricated by the inventive method is based on the graphite/NMC cell couple that utilizes nanometer scale coatings of Ni or Cu coatings to enable long cycle life (500 cycles) at extreme fast charging rates (6C) while maintaining state of the art cell specific energy and cost. The presence of Ni and/or Cu coatings on graphite anodes was found to increase the Li nucleation overpotential relative to the uncoated graphite anode, thus suppressing Li deposition and allowing for charging at higher rates compared to an unmodified graphite anode. As the inventive cell or battery used current state of the art electrode materials (graphite and 622 NCM), with the only difference being modification of the graphite electrode surface via a facile physical vapor deposition (PVD) method, the cost of the proposed cell will be similar to the current state of the art. Furthermore, because the metal coatings are primarily be on the surface of the graphite anode electrode, there will not be a significant decrease in cell specific energy. For a graphite anode electrode with 8 mg/cm² loading, assuming surface deposition, the mass of a 5 nm Cu coating will be <1 mg Cu per g of graphite. Another advantage of the proposed technology is that the physical vapor deposition step is favorable for industrial scale up.

Feasibility—previous reports have shown that nickel (Ni) and copper (Cu) metal substrates exhibit high overpotentials unfavorable for lithium deposition (FIG. 2), as reported by Yan, K., et al., Selective deposition and stable encapsulation of lithium through heterogeneous seeded growth. Nat. Energy (2016); 1(3): p. 16010; Pei, A., et al., Nanoscale Nucleation and Growth of Electrodeposited Lithium Metal. Nano Letters (2017); 17 (2): p. 1132-1139; Wang, H.-C., et al., Fabrication and Characterization of Ni Thin Films Using Direct-Current Magnetron Sputtering. Chinese Physics Letters (2005); 22(8): p. 2106.

The ultrathin surface coatings of Ni and Cu metal were applied to the graphite electrodes via a DC magnetron sputtering method. The preparation of ultra-thin films with controlled thicknesses of 10 nm or less via DC magnetron sputtering was previously demonstrated for both Cu, as described by Prater, W.L., et al., Microstructural comparisons of ultrathin Cu films deposited by ion beam and dc-magnetron sputtering. Journal of Applied Physics (2005); 97(9): p. 093301 and Ni Wang, H.-C., et al., Fabrication and Characterization of Ni Thin Films Using Direct-Current Magnetron Sputtering. Chinese Physics Letters (2005); 22 (8): p. 2106 metals. The sputtering instrument that will be utilized for the deposition will be able to accommodate electrodes of suitable size for pouch cell assembly.

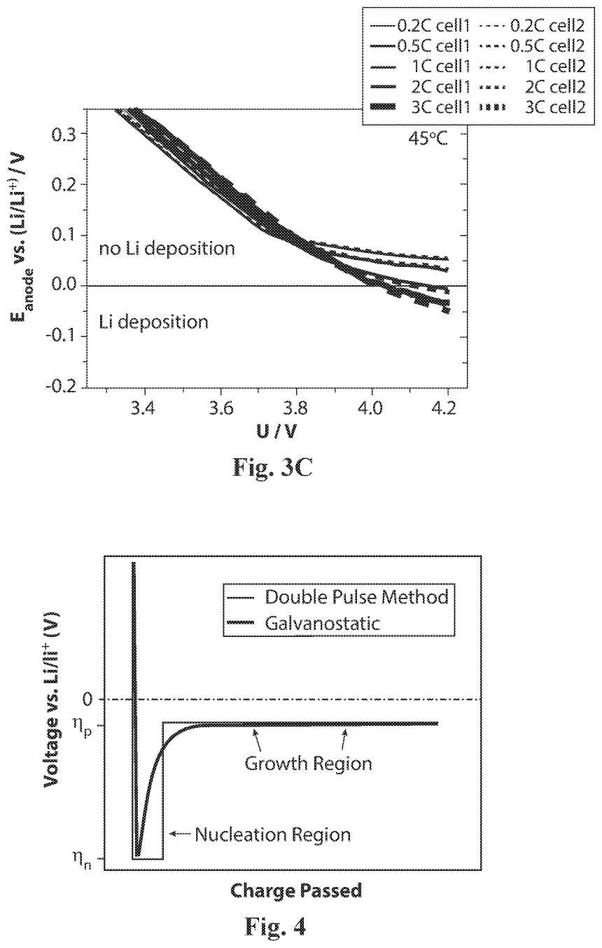

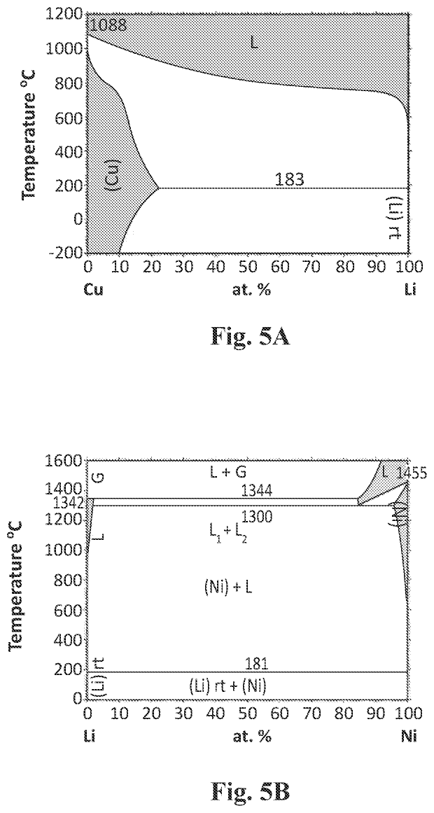

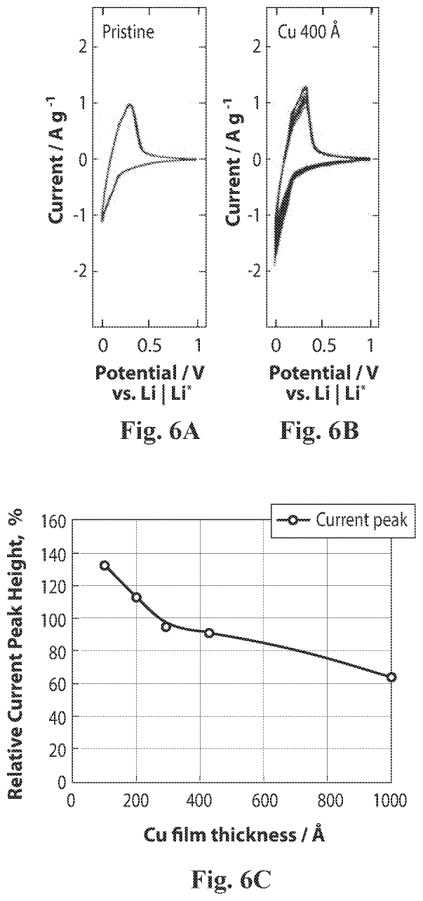

Surface modification of graphitized carbon anode materials with Cu and Ni metal coatings has been explored previously to modify the sold-electrolyte interphase (SEI) (F. Nobili, et al. J. Power Sources, 180, 845 (2008); M. Mancini, et al. J. Power Sources, 190, 141 (2009); M. Mancini, et al. J. Power Sources, 190, 141 (2009); P. Yu, et al. J. Electrochem. Soc., 147, 2081 (2000); F. Nobili, et al. Fuel Cells (Weinheim, Ger.), 9, 264 (2009)), providing proof of concept for the intercalation of Li ions through the metal films. This research demonstrated that Li⁺ions can effectively (de)intercalate through 5-40 nm thick Cu films into a graphitized carbon fiber substrate, J. Suzuki, et al. Electrochem. Solid-State Lett., 4, A1 (2001), as illustrated in FIG. 4, and Cu films were found to facilitate the charge transfer process on an oxidized graphite electrode, with consistently lower impedance observed over a range of voltages compared to a pristine electrode. (FIGS. 8a and 8b) Sethuraman, V. A., K. Kowolik, and V. Srinivasan, Increased cycling efficiency and rate capability of copper-coated silicon anodes in lithium-ion batteries. Journal of Power Sources (2011); 196(1): p. 393-398. Also see, (FIGS. 6a-c). F. Nobili, et al. J. Power Sources, 180, 845 (2008). The improved kinetics were attributed to a catalytic effect of the metal coating for the desolvation of Li cations from the electrolyte. F. Nobili, et al. Fuel Cells (Weinheim, Ger.), 9, 264 (2009).

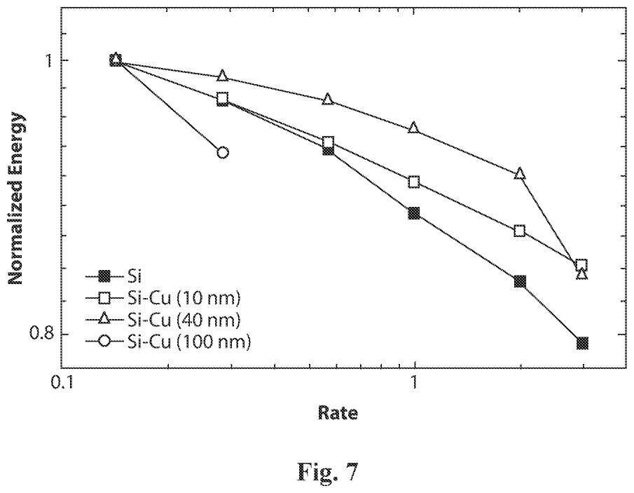

Further evidence for the intercalation of Li ions through nm scale Cu films is provided by reports of Cu coated Si and Si/graphite composite electrodes, as reported by Sethuraman, V. A., K. Kowolik, and V. Srinivasan, Increased cycling efficiency and rate capability of copper-coated silicon anodes in lithium-ion batteries. Journal of Power Sources 2011); 196(1): p. 393-398. Yen, J.-P., et al., Sputtered copper coating on silicon/graphite composite anode for lithium ion batteries. Journal of Alloys and Compounds (2014); 598 (Supplement C): p. 184-190. In these reports, DC magnetron sputtering was used to deposit Cu films on the surface of the electrodes, with the surface films ranging from 10-100 nm in thickness. SEM and EDX analysis were used to confirm that the Cu films were uniform across the electrodes. The presence of Cu coating was found to improve cycling efficiency and deliverable energy relative to uncoated Si anode at rates as high as 3C. (FIG. 7). Sethuraman, V. A., K. Kowolik, and V. Srinivasan, Increased cycling efficiency and rate capability of copper-coated silicon anodes in lithium-ion batteries. Journal of Power Sources (2011); 196(1): p. 393-398. Diffusion of Li through Ni metal has also been demonstrated in multilayer Ni/NiO thin film electrodes, as reported by Evmenenko, G., et al., Lithiation of multilayer Ni/NiO electrodes: criticality of nickel layer thicknesses on conversion reaction kinetics. Phys. Chem. Chem. Phys. (2017); 19(30): p. 20029-20039; Evmenenko, G., et al., Morphological Evolution of Multilayer Ni/NiO Thin Film Electrodes during Lithiation. ACS Applied Materials& Interfaces (2016 8(31): p.19979-19986. Results showed that Li ion transport was effective through Ni layers <˜7.5 nm., as reported by Evmenenko, G., et al., Lithiation of multilayer Ni/NiO electrodes: criticality of nickel layer thicknesses on conversion reaction kinetics. Phys. Chem. Chem. Phys. (2017); 19(30): p. 20029-20039.

While the invention has been shown and described with reference to certain embodiments of the present invention thereof, it will be understood by those skilled in the art that various changes in from and details may be made therein without departing from the spirit and scope of the present invention and equivalents thereof.

What is claimed is:

1. An anode configured for fast charging a lithium-ion battery comprising:
an anode substrate;
a nanocoating provided on a surface of the anode substrate selected from the group of nanocoatings consisting of: Cu, Ni, and a composite of Cu and Ni;
wherein the coating increases an overpotential of Li metal nucleation at the coated surface of the at least one electrode to inhibit Li metal plating during extreme fast charging.
2.2. The anode of claim 1, wherein extreme fast charging is charging conducted in less than 20 minutes.

3. The anode of claim 1, wherein the coating is a nanocoating with a thickness in a range of 2-200 nm.

4. The anode of claim 3, wherein the nanocoating has a thickness in a range of 2-10 nm.

5. The anode of claim 1, wherein the anode substrate is selected from the group consisting of: graphite, carbon black and polyvinyl fluoride (PVDF).

6. The anode of claim 4, wherein the anode substrate is graphite, the coating is about 5 nm in thickness and, at a loading of around 8 mg/cm², a mass of metal comprising the coating is less than 1 mg per g of graphite.

7. The anode of claim 2, wherein the extreme fast charging is conducted in approximately 10 minutes.

8. The anode of claim 1, wherein the overpotential is determined by an interfacial energy difference between the substrate and the Li metal, which interfacial energy difference is dependent upon a dissimilarity in crystal structure.

9. The anode of claim 1, wherein the coating comprises a composite nanonolayer of Cu and Ni on the anode substrate surface.

10. A method for fabricating an anode for fast charging a lithium-ion battery, the method comprising:
coating a surface of an anode substrate with a layer of Cu, a layer of Ni or a layer of Cu and a layer of Ni, to yield an anode with an increased overpotential of Li metal nucleation at the coated surface and thereby inhibit Li metal plating during extreme fast charging of a lithium-ion battery fabricated with the anode.

11. The method of claim 10, wherein coating includes applying a nanolayer of Ni directly on the anode substrate surface and applying a layer of Cu directly on the layer of Ni to form the composite nanolayer.

12. The method of claim 10, including applying the coating to the anode by physical vapor deposition (PVD).

13. The method of claim 12, including evaporating the Cu, the Ni or both Cu and Ni under vacuum from a heated tungsten crucible.

14. The method of claim 10, including applying the coating at a thickness in a range of about 2-200 nm.

15. The method of claim 14, wherein the coating is applied at a thickness of about 2-10 nm.

16. The method of claim 15, wherein the coating is applied at a thickness of approximately 5 nm and, wherein at a loading of around 8 mg/cm², a mass of metal comprising the coating is less than 1 mg per g of graphite.

17. The method of claim 10, wherein the increased overpotential is based on an interfacial energy difference between a substrate material from which the anode substrate is formed and the Li metal.

18. The method of claim 11, including fabricating the anode substrate using a slurry casting method.

19. A lithium-ion battery cell including an anode configured for fast charging the lithium-ion battery, comprising:
an anode substrate;
a nanocoating on a surface of the anode substrate selected from the group consisting of: a Cu nanolayer, a Ni nanolayer, and a composite nanolayer of Cu and Ni;
wherein the coating increases an overpotential of Li metal nucleation at the coated surface of the anode substrate to inhibit Li metal plating during extreme fast charging of the lithium-ion battery cell.

20. The lithium-ion battery cell of claim 19, wherein the lithium-ion battery cell is a lithium-ion battery.

21. The lithium-ion battery cell of claim 19, wherein the coating comprises a composite nanolayer of Cu and Ni on the Cu anode substrate.

22. An anode configured for fast charging a lithium-ion battery comprises an anode substrate and a coating on a surface of the anode substrate to increase an overpotential of Li metal to inhibit Li metal plating during extreme fast charging a battery fabricated with the lithium-ion battery, wherein the anode is fabricated by a process comprising:
applying a nanocoating to the anode substrate surface selected from the group consisting of: a Cu nanolayer, a f Ni nanolayer and a composite nanolayer of Cu and Ni.

23. The anode of claim 22, wherein the applying yields a nanocoating with a thickness between approximately 2 and 200 nm.

24. The anode of claim 23, wherein nanocoating thickness is between 2 and 10 nm.

25. The anode of claim 22, wherein the nanocoating is applied to the anode by physical vapor deposition (PVD).

26. The anode of claim 22, wherein the applying includes evaporating the Cu, the Ni or both Cu and Ni, under vacuum from a heated tungsten crucible.

27. The anode of claim 24, wherein the nanocoating is applied at a thickness of approximately 5 nm and, wherein at a loading of around 8 mg/cm², a mass of metal comprising the coating is less than 1 mg per g of graphite.

28. The anode of claim 24, wherein the increased overpotential is based on an interfacial energy difference between a substrate material from which the anode substrate is formed and the Li metal.

29. The anode of claim 24, including fabricating the anode substrate using a slurry casting method.
